(19) United States
(12) Patent Application Publication
(10) Pub. No.: US 2013/0001939 A1
(43) Pub. Date: Jan. 3, 2013

(54) SAFTEY ROLL BAR FOR STROLLERS

(76) Inventor: Lynne Marie Celia, Falls Church, VA (US)

(21) Appl. No.: 13/537,037

(22) Filed: Jun. 28, 2012

Related U.S. Application Data
(60) Provisional application No. 61/501,995, filed on Jun. 28, 2011.

(51) Int. Cl. B60R 21/13

(52) U.S. Cl. 280/756

(57) ABSTRACT

A roll bar for a stroller, such as a jogging stroller, can help protect a child sitting in the stroller in case of an accident. The roll bar system can be integrated into the design of a stroller, or an existing stroller can be retrofitted to include the roll bar system. The roll bar system includes at least one longitudinal member, spanning from an upper portion of the stroller to a lower portion of the stroller, and at least one equatorial member, spanning from one side of the stroller to the other side of the stroller. The roll bar system can include a hinge and a locking mechanism to permit access inside the stroller.

### CROSS-REFERENCE TO RELATED APPLICATION

This application claims the benefit of priority of U.S. provisional application No. 61/501,995, filed Jun. 28, 2011, the contents of which are herein incorporated by reference.

### BACKGROUND OF THE INVENTION

The present invention relates to strollers and stroller accessories, and more particularly, to a light-weight safety roll bar for strollers, especially for jogging strollers.

When parents or caregivers jog with their babies in jogging strollers, they usually do it on trails shared with others, such as on bike trails. Bike trails are usually very busy, having very narrow two-way lanes with people jogging, biking, walking, and the like. The bikers tend to ride extremely fast and pass slower moving walkers and joggers. Accidents happen quite often, with many near misses.

Conventional jogging strollers are wide open and very exposed, with only a three or five point soft harness system holding the child in place. Typically, there is nothing covering or protecting the child if they were involved in an accident involving a cyclist, a runner, or even a car, as bike paths often require crossing streets. At best, these strollers may have a feeding tray that can be used for holding snacks or a sippie cup and are not meant to provide a structural, safety feature.

As can be seen, there is a need for a safety roller bar that can be disposed on a stroller to help protect a child harnessed in the stroller.

### SUMMARY OF THE INVENTION

In one aspect of the present invention, a safety roll bar assembly for a stroller comprises at least one longitudinal member configured to be positioned longitudinally from an upper portion of the stroller to a lower, front portion of the stroller; at least one equatorial member, interconnected with the at least one longitudinal member, spanning from a first side of the stroller to a second, opposite side of the stroller; and at least one latch mechanism adapted to secure the at least one equatorial member to at least one of the first side and the second side of the stroller.

In another aspect of the present invention, a stroller comprises at least one longitudinal member be positioned longitudinally from an upper portion of the stroller to a lower, front portion of the stroller, the at least one longitudinal member disposed in front of a child's stroller seat; at least one equatorial member, interconnected with the at least one longitudinal member, spanning from a first side of the stroller to a second, opposite side of the stroller; and at least one latch mechanism adapted to secure the at least one equatorial member to at least one of the first side and the second side of the stroller.

In a further aspect of the present invention, a safety roll bar assembly for a stroller comprises at least one longitudinal member configured to be positioned longitudinally from an upper portion of the stroller to a lower, front portion of the stroller; at least one equatorial member, interconnected with the at least one longitudinal member, spanning from a first side of the stroller to a second, opposite side of the stroller; at least one latch mechanism adapted to secure a first side of the at least one equatorial member to the first side of the stroller; and at least a first hinge member disposed on a second, opposite side of the at least one equatorial member, the first hinge member operable to pivotably connect the second side of the stroller; wherein the latch mechanism connects a second, opposite end of the equatorial member with the second side of the stroller.

These and other features, aspects and advantages of the present invention will become better understood with reference to the following drawings, description and claims.

### BRIEF DESCRIPTION OF THE DRAWINGS

FIG. 1 is a perspective view of a stroller having a roller bar according to an exemplary embodiment of the present invention;

FIG. 2 is a perspective view of the stroller of FIG. 1, showing the roller bar in an open configuration, according to an exemplary embodiment of the present invention;

FIG. 3 is a detailed perspective view showing an exemplary attachment mechanism for securing the roller bar to the stroller frame;

FIG. 4 is a left side view of the stroller of FIG. 1;

FIG. 5 is a cross-sectional view taken along line 5-5 of FIG. 4;

FIG. 6 is a right side view of the stroller of FIG. 1;

FIG. 7 is a perspective view of a stroller retrofitted for a roller bar according to an exemplary embodiment of the present invention;

FIG. 8 is a perspective view of the stroller of FIG. 7, with the roller bar in an open configuration; and

FIG. 9 is a perspective view of a stroller having a double horizontal tubing roller bar, according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a roll bar for a stroller, such as a jogging stroller, that can help protect a child sitting in the stroller in case of an accident. The roll bar system can be integrated into the design of a stroller, or an existing stroller can be retrofitted to include the roll bar system. The roll bar system of the present invention includes at least one longitudinal member, spanning from an upper portion of the stroller to a lower portion of the stroller, and at least one equatorial member, spanning from one side of the stroller to the other side of the stroller. The roll bar system can include a hinge and a locking mechanism to permit access inside the stroller.

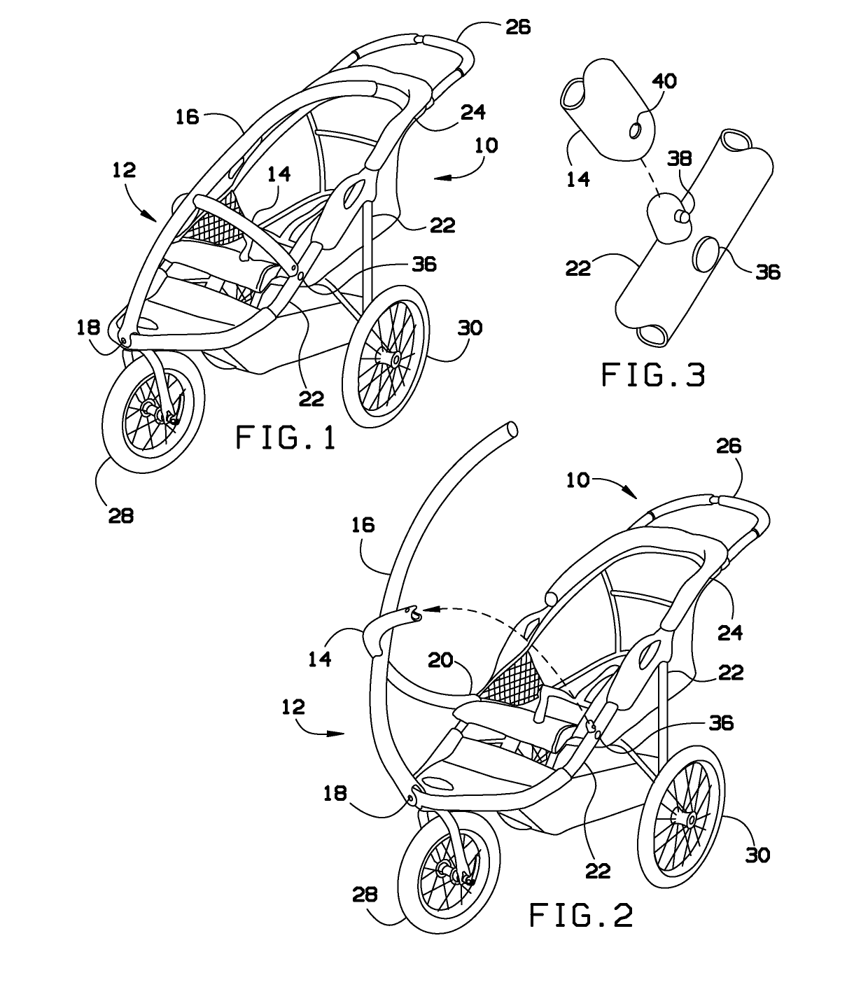

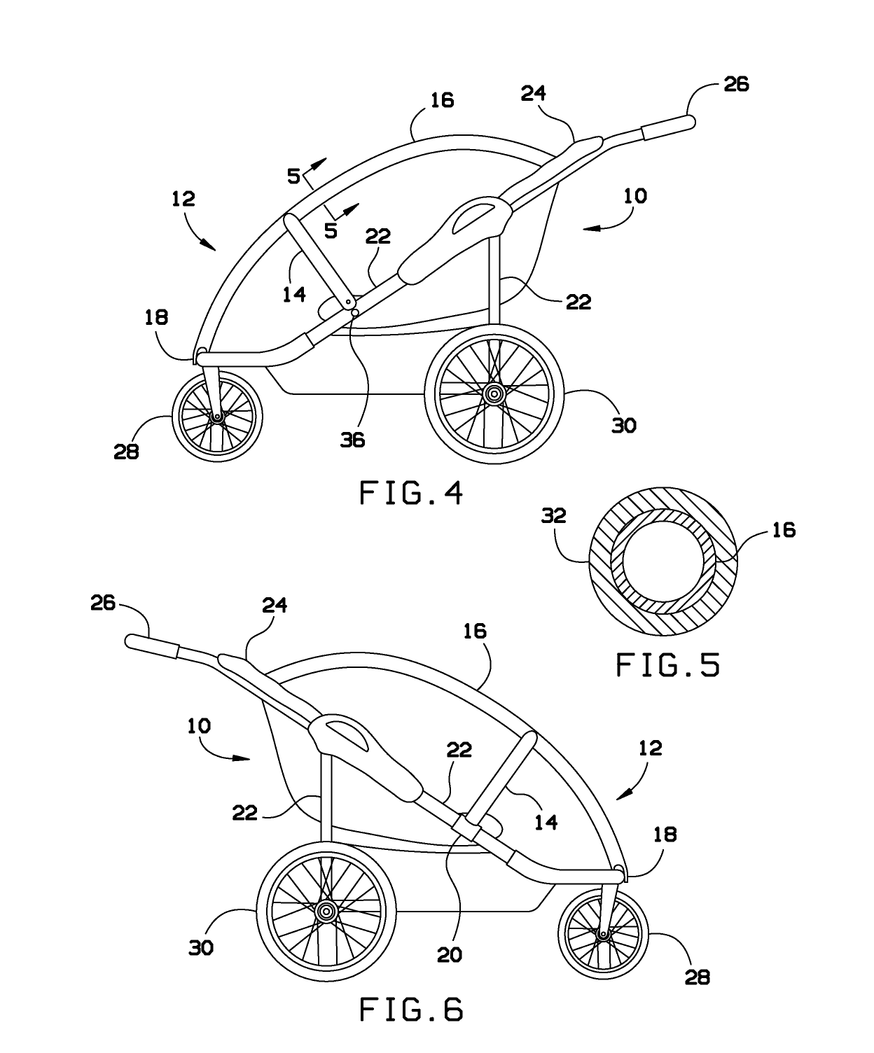

Referring now to FIGS. 1 through 6, a roll bar assembly 12 may be formed as part of a jogging stroller 10. The jogging stroller 10 may be of various designs, including, for example, a stroller with two rear wheels 30 and a single front wheel 30, as shown in the Figures. However, the roll bar assembly 12 of the present invention may also function properly regardless of the stroller design.

The roll bar assembly 12 can include at least one equatorial member 14, spanning from side to side of the stroller 10, and at least one longitudinal member 16, spanning from an upper portion to a lower portion of the stroller 10. The equatorial member 14 and the longitudinal member 16 typically join at a location (or multiple locations, where more than one of the members 14, 16 are present) in front of where a child would sit in the stroller 10. The equatorial and longitudinal members 14, 16 may be made from a strong, light-weight material, such as aluminum, plastic, composite, carbon fiber, and the like.

The roll bar assembly 12 may attach to the stroller 10 at one or more locations, which may be hinge points, latching points or simply support points. For example, a front hinge point 18, located on the stroller frame 22 near a front wheel 28 of the stroller 10, may pivotably attach a lower end of the longitudinal member 16 with a front of the stroller frame 22. A roll bar side hinge point 20 may pivotably connect a pivot end of the equatorial member 14 with a side portion of the stroller frame 22. A latching point may be formed on an opposite side (latch side) of the equatorial member 14. The latching point may removably secure the equatorial member 14 to the stroller frame 22 in various manners. For example, a locking pin hole 40 may be disposed through the equatorial member 14. A locking pin 38, secured to the stroller frame 22, may engage with the locking pin hole 40. A locking pin release button 36 may withdraw the locking pin 38 from the locking pin hole 40, allowing the roller bar assembly 12 to be pivoted on its hinge points 18, 20. A support point may or may not be present on an upper end of the longitudinal member 16. The support point may be formed from the longitudinal member 16 resting against the stroller frame 22 when the roller cage assembly 12 is closed (as shown in FIG. 1).

While the above describes a hinge point 18 on the front of the stroller 10, the hinge point 18 can be excluded or the hinge point 18 could be formed at the upper end of the longitudinal member 16 with the stroller frame 22 near the stroller sun shade 24 or the stroller handle 26.

While the above description refers to an integrated roll bar assembly 12, a release mechanism (not shown) may be formed to release the hinge points 18, 20, allowing the roll bar assembly 12 to be removed from the stroller 10, if desired.

In some embodiments of the present invention, as shown in FIG. 5, at least a portion of the roll bar assembly 12 can be covered in a padding 32. While such padding 32 may not be necessary if a child is situated in the harness in the stroller 10, the padding 32 could offer an additional level of protection for the child.

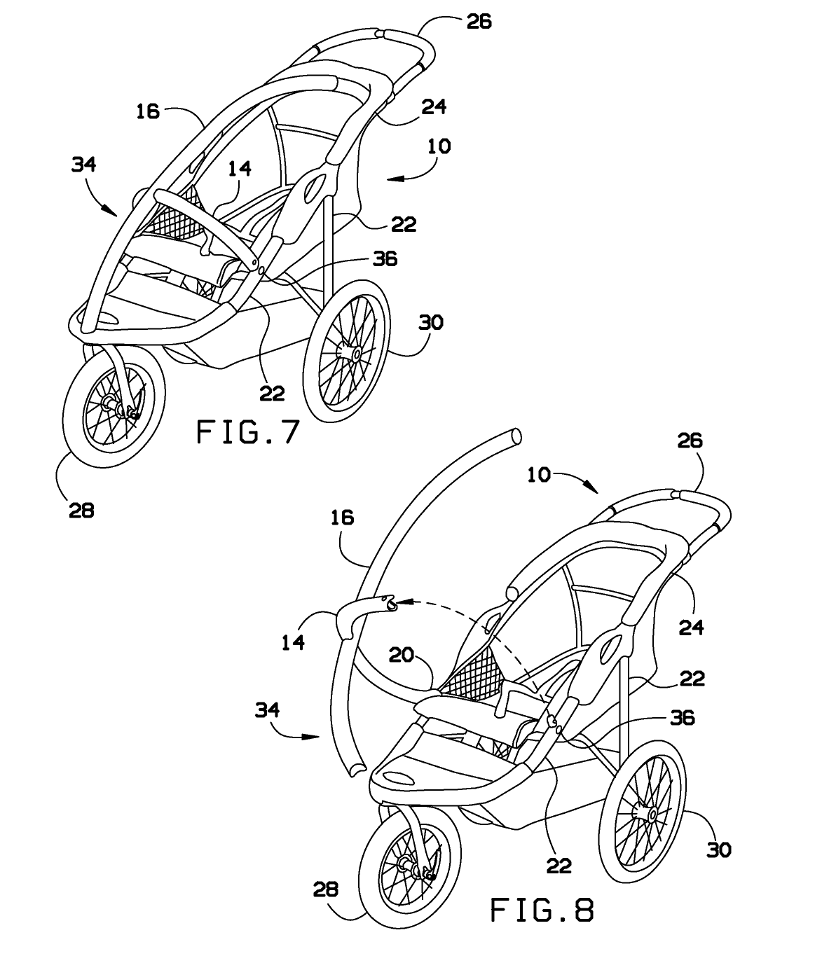

Referring now to FIGS. 7 and 8, a single hinged safety roll bar assembly 34 may be similar to that described above, except that the hinge point 18 is not included. In this embodiment, the hinge point 20 and the latching mechanism (such as the pin 38 and pin hole 40) are disposed on the equatorial member 14.

The hinge point 20 may be designed as a removable clamp-on piece that can clamp securely on the stroller frame 22 and permit the equatorial member 14 to pivot thereupon. Various mechanisms can be used to secure the hinge point 20 to the stroller frame 22, as can be appreciated and contemplated in the art.

The embodiment of the roll bar assembly 34 of FIGS. 7 and 8 may be used to retrofit an existing stroller 10 to include a safety roll bar. In this case, the latch mechanism may also securely clamp on the stroller frame 22, providing a point for the equatorial member 14 to latch to on the opposite side (opposite of the hinge point 20) of the stroller 10.

In some embodiments of the present invention, a latch member may securely attach to the stroller frame 22 on each side of the stroller 10 and the equatorial member 14 can engage with these latch members. In this embodiment, the roll bar assembly 34 can be removed from the stroller 10 by disengaging both latch members, such as by pressing a latch release button 36 to release the locking pin 38 from the locking pin hole 40 in the equatorial member 14.

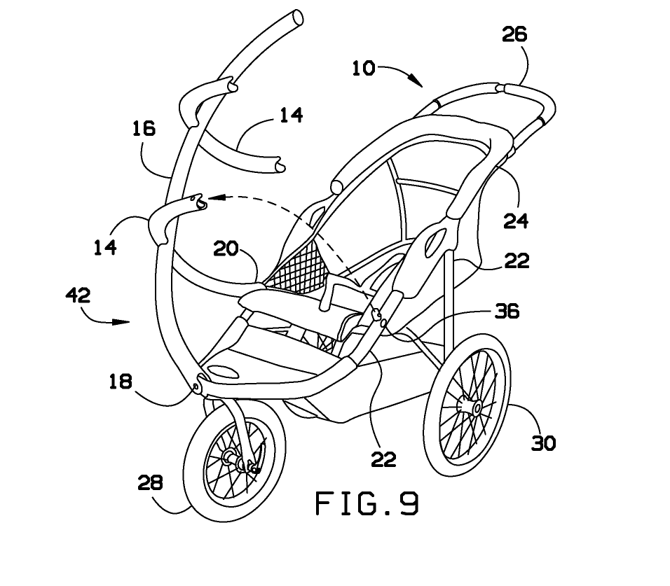

Referring now to FIG. 9, in some embodiments multiple equatorial members 14 and/or multiple longitudinal members 16 may be used to design a modified roll bar assembly 42. For example, as shown in FIG. 9, two equatorial members 14 may be disposed on the roll bar assembly 42. In the embodiment of FIG. 9, the roll bar assembly 42 may be hinged at hinge points 18 and 20, with a single latching mechanism. However, in some embodiments, the roll bar assembly may be hinged by one or more of the equatorial members 14 and may include one or more latching mechanisms.

While the above description uses the roll bar assembly for a stroller, such as a jogging stroller, the roll bar assembly of the present invention could be used in other similar items. For example, the roll bar assembly could provide child protection and safety in a bicycle child trailer, which may be towed behind a ridden bicycle, or, in some embodiments, can be mounted in front of a ridden bicycle.

It should be understood, of course, that the foregoing relates to exemplary embodiments of the invention and that modifications may be made without departing from the spirit and scope of the invention as set forth in the following claims.

What is claimed is:

1. A safety roll bar assembly for a stroller comprising:
at least one longitudinal member configured to be positioned longitudinally from an upper portion of the stroller to a lower, front portion of the stroller;
at least one equatorial member, interconnected with the at least one longitudinal member, spanning from a first side of the stroller to a second, opposite side of the stroller; and
at least one latch mechanism adapted to secure the at least one equatorial member to at least one of the first side and the second side of the stroller.

2. The safety roll bar assembly of claim 1, further comprising at least a first hinge point disposed on a first side of the stroller, the first hinge point pivotably connecting a first end of the equatorial member.

3. The safety roll bar assembly of claim 2, wherein the latch mechanism connects a second, opposite end of the equatorial member with the second side of the stroller.

4. The safety roll bar assembly of claim 2, further comprising a second hinge point disposed on one of a first end and a second end of the longitudinal member.

5. The safety roll bar assembly of claim 3, wherein the latch mechanism includes a locking pin secured to the second side of the stroller and a locking pin hole disposed in the equatorial member, wherein the locking pin removably engages the locking pin hole.

6. The safety roll bar assembly of claim 1 wherein the at least one longitudinal member is one longitudinal member and the at least one equatorial member is two equatorial members.

7. The safety roll bar assembly of claim 1, wherein the safety roll bar is operable to retrofit onto an existing stroller.

8. The safety roll bar assembly of claim 1, wherein the safety roll bar is integrated into a stroller design.

9. A stroller comprising:
at least one longitudinal member be positioned longitudinally from an upper portion of the stroller to a lower, front portion of the stroller, the at least one longitudinal member disposed in front of a child's stroller seat;
at least one equatorial member, interconnected with the at least one longitudinal member, spanning from a first side of the stroller to a second, opposite side of the stroller; and
at least one latch mechanism adapted to secure the at least one equatorial member to at least one of the first side and the second side of the stroller.

10. The stroller of claim 9, further comprising at least a first hinge point disposed on a first side of the stroller, the first hinge point pivotably connecting a first end of the equatorial member.

11. The stroller of claim 10, wherein the latch mechanism connects a second, opposite end of the equatorial member with the second side of the stroller.

12. A safety roll bar assembly for a stroller comprising:
at least one longitudinal member configured to be positioned longitudinally from an upper portion of the stroller to a lower, front portion of the stroller;
at least one equatorial member, interconnected with the at least one longitudinal member, spanning from a first side of the stroller to a second, opposite side of the stroller;
at least one latch mechanism adapted to secure a first side of the at least one equatorial member to the first side of the stroller; and
at least a first hinge member disposed on a second, opposite side of the at least one equatorial member, the first hinge member operable to pivotably connect the second side of the stroller;
wherein the latch mechanism connects a second, opposite end of the equatorial member with the second side of the stroller.
